(19) United States
(12) Patent Application Publication
(10) Pub. No.: US 2025/0224512 A1
(43) Pub. Date: Jul. 10, 2025

(54) SYSTEM AND METHOD FOR DETERMINING THE POSITION OF A FLYING BODY

(71) Applicant: Mikado Model Helicopters GmbH, Potsdam (DE)

(72) Inventors: Ralf Buxnowitz, Potsdam (DE); Ulrich Röhr, Hanau (DE)

(21) Appl. No.: 18/280,541

(22) PCT Filed: Feb. 23, 2022
(86) PCT No.: PCT/EP2022/054485

§ 371 Date: Mar. 5, 2025

(30) Foreign Application Priority Data
Mar. 8, 2021 (DE) 10 2021 105 524.5

(51) Int. Cl. G01S 15/74; G01S 15/86

(52) U.S. Cl. CPC G01S 15/74; G01S 15/86

(57) ABSTRACT

A method and a system for detecting the position of a flying body, which has at least two ultrasonic transducers arranged on the flying body, and to a stationary or mobile temporarily static base station, which is able to be arranged in a preferably freely selectable reference position (x_{R}, y_{R}, z_{R}), said base station having a signal analysis device and a plurality of acoustic transducers, which are arranged on the base station in a mutually spaced manner and which are designed to receive the ultrasonic signals of the two ultrasonic transducers, and a radio controller, which is designed to communicate with the flying body and control the same by means of radio signals, preferably by means of radio signals according to a frequency-hopping spread spectrum (FHSS) method.

### CROSS REFERENCE TO RELATED APPLICATIONS

This application is a 35 U.S.C. § 371 national phase application of International Application No.: PCT/EP2022/054485, filed Feb. 23, 2022, which claims the benefit of priority under 35 U.S.C. § 119 to German Patent Application No.: 10 2021 105 524.5, filed Mar. 8, 2021, the contents of which are incorporated herein by reference in their entirety.

### FIELD

The invention relates to a device or a system and method for determining the position of a flying body.

### BACKGROUND

The statements in this section merely provide background information related to the present disclosure and several definitions for terms used in the present disclosure and may not constitute prior art.

Positioning outdoors and also in buildings or in built-up areas is becoming increasingly important. Due to the rapid development of communication and information technologies in recent years, there is an ever-growing demand for localization options. For outdoor applications, GPS has become established as a standard in the prior art. For indoor applications, due to signal shielding, satellite-based positioning is hardly possible, or at least too inaccurate or partially not available at all. The usual methodology with the solutions mentioned, GPS and magnetic compass, has overall greater drawbacks, such as the comparatively low accuracy, slow updates, high costs, and the need for a free view of the satellites. Furthermore, GPS alone is not sufficient anyway since an alignment is still required for control. All sensors are subject to strong interfering influences, e.g., in the vicinity of buildings, and are therefore not usable indoors. For this reason, there are various alternative realizations for indoor use in buildings. Partly, the existing infrastructure, such as Wi-Fi or GSM, is used. On conceivable applications for such systems.

Such systems are already in use in the logistics industry to locate goods and commodities within warehouses. However, there are also applications which go beyond mere positioning and further require positioning which is as accurate as possible. Thus, with remote-controlled flying bodies, the flight maneuver is also relevant in addition to positioning.

In general, the position of a mobile unit is not known, while multiple stationary stations are used for measurement. Methods are described in the prior art as to how localization can take place under these conditions. By measurement, this can be done either by triangulation (angulation), the determination of angles, or by means of trilateration (lateration, distance measurement), the measurement of paths. Furthermore, positioning is also carried out on the basis of scene analysis or by determination of proximity.

In the so-called “time of arrival” (TOA) method, the transit time of the signals between the transmitter and receiver is measured. This can be used to determine the distance between the transmitter and receiver, but not the position. If the measurement is carried out one-way, i.e., the signals are only analyzed at the receiver, the two units must be synchronized on the basis of the signal transit time. If such a distance measurement is now carried out from three different locations, trilateration can be performed to detect a position. However, this requires three positions for trilateration. The same applies to the time difference method, which is based on the time difference measurement between the mobile unit, such as a flying body, and the three stationary stations. If the mobile unit then assumes the role of the transmitter, at least three base stations receive this signal. This method is also complex and complicated and has various drawbacks.

The name “access point monitoring” is understood to mean a positioning method in which the base stations define a cell structure. The receiver always connects to the base station. If the receiver is connected to a base station, it must consequently be located in the catchment area of this station. Then, if the positions of the base stations are also known, positioning of the mobile station can also take place. This solution is completely unsuitable for remote-controlled flying bodies, such as, for example, remote-controlled helicopters or drones, since these must be maneuvered in a constrained space, for which not only a close-meshed network of base stations would be required, but would also require the positions of the base stations to be defined first.

When using ultrasound for position detection, transit time measurements of sent ultrasound pulses of an ultrasound sensor are utilized to be able to derive spatial distances therefrom. By means of this distance detection, positioning is subsequently performed by trilateration. As such, the signals are either transmitted by a mobile transmitter and received by permanently installed receivers or, conversely, signals are transmitted by permanently mounted transmitters which are detected by mobile receivers. Ultrasonic waves exhibit a frequency of between 20 kHz and 1 GHz. Depending on the density of the material, they are either reflected, absorbed or pass through the material. This must be taken into account when distributing the sensor stations. Within the air, ultrasonic waves are increasingly attenuated with increasing frequency. The propagation rate also depends on the temperature of the medium. This influence must optionally be included in the position calculation and represents a great drawback when using ultrasound for positioning together with trilateration.

Various other methods are also known, which will not be described in detail below, since they are also not suitable for detecting the position of remote-controlled flying objects.

All conventional methods are not particularly suitable for determining the position of remote-controlled flying objects both indoors and outdoors, since, in addition to the actual positioning, the flight maneuver must also correlate with the position, which is a great challenge, in particular in take-off and landing maneuvers. Specifically, if the flying object is to be flown or maneuvered precisely to a specific point in space or on the ground, for example, to fulfill a task there (e.g., docking to a charging station on the ground), the exact maneuver can be guaranteed only if an almost synchronous detection of the exact position is carried out with the highest detection accuracy possible. As such, accuracies as with GPS, which are typically in the meter range, are far from sufficient.

Further, the availability at a variable distance from the radio controller also plays a role and, in particular, the ability to be able to map a specific range at all. Typical ranges, e.g., in the laser tracking method, which is also used indoors, are only between 15 and 70 meters.

So-called GSNN systems are designed for outdoor use. For GPS, the measurement is performed using the time-of-arrival method, with the signals having to be received from at least 4 satellites. However, indoors, these signals are reflected or absorbed by the walls. However, in order not to have to do without the global availability of GPS, the so-called Assisted GPS was developed. Here, the receiver attempts to receive weak GPS signals, if this is possible at all. Additional positional information is obtained via the additional mobile telephone network (if present), whereby the reception of the GPS signals is to be facilitated. Thus, using the satellite-based augmentation system (SBAS) enables a positioning accuracy of only 10 meters, which is also completely inadequate for being able to maneuver and control remote-controlled flying bodies as desired and for being able to perform a safe landing. GPS has particular problems between urban canyons, in built-up areas and behind barriers.

### SUMMARY

An objective of the present disclosure is to overcome the above-mentioned drawbacks and to provide a solution which works with high accuracy both in the interior (indoors) and in the exterior (outdoors). Another objective is that the reference position itself should be variable, so that the flight system works at various locations regardless of permanently stationary base stations.

This objective is achieved by the combination of features associated with a system for detecting the position of a flying body, which has at least two ultrasonic transducers arranged on the flying body, and a stationary or mobile base station positionable locally temporally, which is able to be arranged in a preferably freely selectable reference position (x_{R}, y_{R}, z_{R}), said base station having a signal analysis device and a plurality of at least three acoustic transducers, which are arranged on the base station in a mutually spaced manner and which are designed to receive the ultrasonic signals of the two ultrasonic transducers, and a radio controller, which is designed to communicate with the flying body and control the same by means of radio signals, preferably by means of radio signals according to a frequency-hopping spread spectrum (FHSS) method, wherein the system is designed to determine the position (x, y, z) of the flying body from the ultrasonic signals of each of the two ultrasonic transducers received from the base station, preferably together with the time information (time measurement) of the radio reference signal from the radio signals used for controlling the flying body.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a representation of a system according to the teachings of the present disclosure;

FIG. 2 shows an algorithm according to the teachings of the present disclosure; and

FIG. 3 shows the example of a signal as recorded by the microphone (curve M).

The drawings are provided herewith for purely illustrative purposes and are not intended to limit the scope of the present invention. The figures are schematic for illustration. Similar reference numbers in the figures indicate similar functional and/or structural features.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein

A basic idea of the present disclosure is to rely on a systemic coupled analysis between ultrasonic signals and radio signals, which are used for controlling the flying object on the basis of the radio connection anyway, as a time reference and for position transmission for this purpose. This not only saves costs but allows a very simple and intuitive use of the system with high accuracy.

The system for position detection according to the present disclosure provides everything required for robust navigation, namely a position as such and an alignment of high update rate and highest precision. This also eliminates the need for cumbersome calibration of the sensors or waiting for favorable satellite constellations.

According to one aspect of the present disclosure, a system for detecting the position of a flying body is provided for this purpose, having at least two ultrasonic transducers arranged on the flying body as well as a stationary or a mobile temporarily static base station, which is able to be arranged at a preferably freely selectable reference position (x_{R}, y_{R}, z_{R}). Thus, for example, a user can place the base station or reference platform at a suitable location and then start the flying object and determine the position relative to the selected location.

The base station has a signal analysis device and a plurality of at least three acoustic transducers which are arranged on the base station in a mutually spaced manner and are designed to receive the ultrasonic signals of the, in particular of the two, ultrasonic transducers. The at least two ultrasonic transducers always produce two immediately consecutive chirps which are sent to the acoustic transducers. For this purpose, the distance analysis is carried out on a plurality of channels or signal links and each microphone (or each acoustic transducer) registers the chirps of each of the ultrasonic transducers. To perform the positioning, e.g., by trilateration, at least three acoustic transducers are required at the base station and the received signals are analyzed.

Further, a radio controller is provided, which is designed to communicate with the flying body and control and maneuver the same by means of conventional radio signals, preferably by means of radio signals according to the frequency-hopping spread spectrum (FHSS) method, wherein the system according to the invention is designed to determine the position (x, y, z) of the flying body in each case from multiple measured values, following one another in time, of the ultrasonic signals received from the base station of each of the two ultrasonic transducers together with the temporal information (time measurement) of the radio reference signal from the radio signals used for controlling the flying body.

In a particularly preferred embodiment of the present disclosure, it is provided that the ultrasonic transducers are designed to send a number of signals or also a number of signals as a signal sequence of chirp signals in the ultrasonic range. The transducers can also be designed with an electronically expanded bandwidth. In addition to the actual positioning by means of the distance measurement, the detection of sequentially successive chirp signals from the respective at least two ultrasonic transducers not only determines the position, but also the position change and thus the velocity of the flying body, e.g., by means of differential measurement analysis.

Hence, the concept of the present disclosure advantageously uses an existing radio link (radio signal) in a wide channel range, thereby eliminating an installation of additional equipment and measures, since the FHSS radio technique carries completely adequate time information, and this time signal can be used. The determined position is then also returned to the flying object via the same radio link. This means that the position (x, y, z) determined by the base station is transmitted to the flying body via the radio channel or via the FHSS signals.

The use of chirps (wideband) for positioning offers various advantages, in particular the possibility of determining the orientation of the flying object by simultaneously analyzing with 2 chirps at 2 transducers via a plurality of radio channels per measurement. An essential advantage is that a dynamically moved object, namely the moving flying body, can be located, thus also enabling the detection of rapid movements, since the otherwise interfering Doppler effect can be efficiently eliminated or significantly reduced with chirps. Suitable chirps ensure the best possible resolution and interference suppression (analog RADAR, pulse compression).

According to the idea of the present disclosure, the ultrasonic signals are used for distance measurement by transit time measurement from the flying body to the base station.

A likewise advantageous embodiment of the present disclosure provides for a combination or coupling of the system according to the invention with an IMU solution. An IMU is an electronic device which typically uses 3-axis accelerometers and 3-axis gyros (which measures rates of rotation). The speed can be derived from the rates of rotation and the changes in position in all 3 spatial directions. Alternatively, an FPS-based solution in combinatorics can be used.

In a particularly advantageous embodiment of the present disclosure, the acoustic transducers represent microphones, preferably broadband microphones, arranged at the base station. As such, the band range should be matched to the transducers.

A particularly advantageous solution provides that the measurement per chirp is carried out simultaneously, i.e., in parallel, across a plurality of channels. In this way, a dynamic movement can be detected. In this advantageous embodiment of the present disclosure, it is accordingly provided that a plurality of channels is used simultaneously in parallel in the ultrasonic signal analysis. It is further advantageous if the ultrasonic transducers are designed to be alternately switchable, so that an optimized spatial and angular coverage can be realized in the ultrasonic signal transmission.

In summary, features of the embodiments according to one aspect of the present disclosure can be defined as follows:
Distance measurement by measuring the transit time of ultrasonic signals;
Open system (no echo);
Time measurement with radio reference from the (already existing) FHSS system;
Transducers (transmitters) in the flying body, receiver in the reference platform;
Two transducers to determine the absolute orientation;
Switchable transducers for complete coverage of all angles if possible;
Use of many channels allows almost any expansion of coverage;
Reference platform specifies the position reference (may be mobile according to the concept of the invention);
Chirps for best possible resolution and interference suppression (such as RADAR, pulse compression);
FHSS hops as a time reference; and
Radio for time reference, position transmission and control at the same time.

In addition to the system, a further aspect of the present disclosure also relates to the method of determining the position of a remotely controllable dynamically movable flying body on which at least two ultrasonic transducers are mounted, preferably with a device as described with the following steps:
a. providing and positioning one or more base stations at a selected reference position (x_{R}, y_{R}, z_{R}), wherein the base station is equipped with a signal analysis device and at least two acoustic transducers for receiving ultrasonic signals from the flying body;
b. providing a radio controller which is designed to communicate with the flying body by means of radio signals, preferably by means of radio signals according to the frequency-hopping spread spectrum (FHSS) method, and to control the same,
c. sending ultrasonic signals to the base station, in particular chirp signals in the ultrasonic range, by each of the at least two ultrasonic transducers across a plurality of channels (radio channels) simultaneously;
d. detecting multiple, in particular at least three, ultrasonic signals received from the acoustic transducers by the signal detection device;
e. detecting the time information (time measurement) of the radio reference signal from the radio signals used to control the flying body; and
f. determining the positional data of the flying body from the detected reference signal and the ultrasonic signals.

In step f), positional data of the transducers can be extracted, in particular by trilateration of the ultrasonic signals from 3 respective acoustic transducers, and can be analyzed together with the time signal such that absolute positional data can be determined therefrom, which are then advantageously transmitted to the flying object via a radio link. The time reference can be provided either by the external transmitter or by the base.

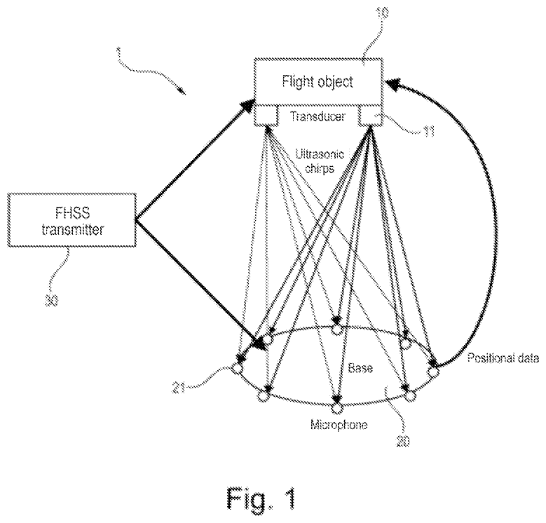

Other aspects of the present disclosure are presented in detail below along with the description of the preferred embodiment of the invention with reference to the figures. The invention is explained in more detail below with reference to FIGS. 1 to 3, the same reference numerals in the figures indicating identical structural and/or functional features.

FIG. 1 shows a first schematic embodiment of the invention and thus an exemplary system 1 for detecting the position of a flying body 10, having two ultrasonic transducers 11 arranged at (the bottom of) the flying body 10. On the ground, there is a temporarily stationary base station 20. It can be easily set up on the ground by a user, for example, so that the 8 microphones 21 shown, which operate as acoustic transducers, are directed upwards. As shown in FIG. 1, they can receive the ultrasonic chirps of the ultrasonic transducers 11.

The position at which the base station 20 was set up defines a reference position (x_{R}, y_{R}, z_{R}). It would be conceivable, for example for indoor applications, to also set up multiple base stations 20 which can communicate with the flying object 10.

Further, a radio controller (30), specifically an FHSS transmitter, is proposed, which is designed to communicate with the flying body 10 by means of the frequency-hopping spread spectrum (FHSS) method, and to control the same.

According to this exemplary embodiment, multiple, preferably 8, transit time measurements were carried out per chirp, wherein the chirps are sent successively for each ultrasonic transducer 11 to the base station 20. 3 measured values per chirp result in one position. If n above k=56 positions per chirp, the analysis of the 2*56 x, y, z position values is carried out. Further, a geometric quality assessment of the data is carried out.

Depending on the distance of the flying body 10 to the base station 20, the process is repeated in an interval of 20 ms to 80 ms. As soon as the signals have been analyzed by the signal analysis unit, the position is transmitted via the FHSS radio link from the base station 10 to the flying object 20.

Therefore, the exemplary embodiment is designed to determine the position (x, y, z) of the flying body 10 from multiple measured values of the ultrasonic signals received from the base station 20 of each of the two ultrasonic transducers 11 together with the time information (time measurement) of the radio reference signal from the radio signals of the FHSS transmitter used for controlling the flying body 10.

For example, Murata MA40 standard components with sufficiently large scattering angles: 120 degrees −6 db can be used as transducers, which work in a changeable manner (normal/inverted flight) depending on the orientation relative to the base.

The control of the chirp1 is generated as an upchirp in the frequency range of 37.5 kHz-46.5 kHz, while the chirp2 operates as a downchirp in the frequency range of 46.5 kHz-37.5 kHz. This data is only exemplary and can also be selected differently depending on the topology of the circuit, the components and the application.

In FIG. 1, microphones are used, which can be micromechanical microphones in the range of 100 Hz-60 kHz.

With the chosen topology, spatial resolutions or positional resolutions of approx. 1 cm at 1 m distance and approx. 10-50 cm at 10 m distance can be achieved. Oversampling also enables a gradual use of the phase information.

A Mikado VLink radio system FHSS 2.4 Ghz is particularly preferred as a radio system. This system has a network structure and allows data packets to be sent from each terminal to any other terminal (transmitter->flight object: controller, base->flight object: positional data, flight object->transmitter: telemetry, base->transmitter: status display).

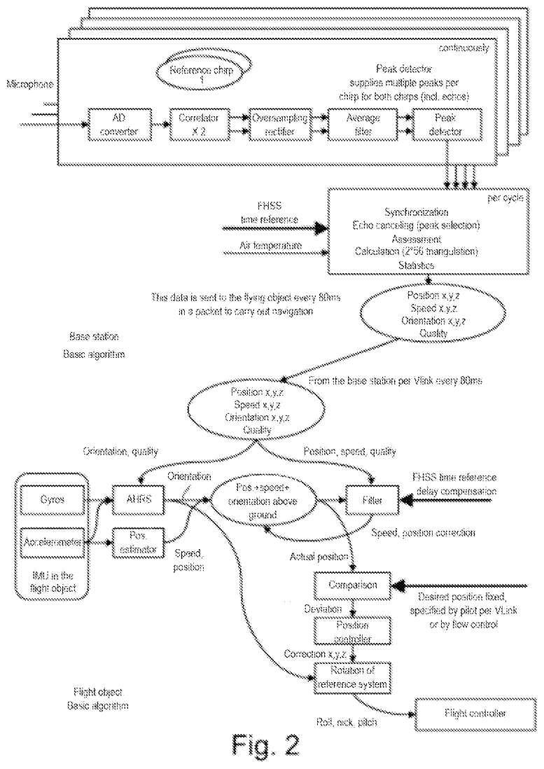

FIG. 2 shows how an algorithm can be implemented for the flying object 10 and the base station 20 according to the idea of the present invention. In the upper region of the illustration, the algorithm for the base station 20 is schematically sketched starting from 8 microphones, wherein only 4 layers are shown by way of example. A peak detector follows at the end of the data link downstream of an average filter. The process up to the peak detector takes place continuously. The chirp signals detected by the microphones 21 are indicated coming from the left. The peak detector supplies multiple peaks for each of the two chirps (of course, the signal echoes are also contained therein). A synchronization with the time signal received via the radio link is carried out per cycle. In addition, the ambient temperature can be detected for setting a temperature corrector. A peak selection and, in particular, a noise elimination of the echoes as well as a calculation of the triangulations (here 2 times 56 triangulations) are carried out, from which the position (x, y, z), speed, orientation and, optionally, the quality are determined.

This data is then transmitted to the flying object 10 in a defined rhythm. Further, an IMU is located in the flying body 10 (e.g., a helicopter). The data, such as orientation, position, and speed, is processed according to the flow chart. By means of a correction loop and the FHSS time reference data, a correction of speed and position can also be carried out. The determined position, speed and orientation above the ground are then compared by means of a comparison with the desired target position, controlled by a user via the radio controller. This data is then supplied to the flight controller as shown in FIG. 2 to control the flight maneuvers on this data basis.

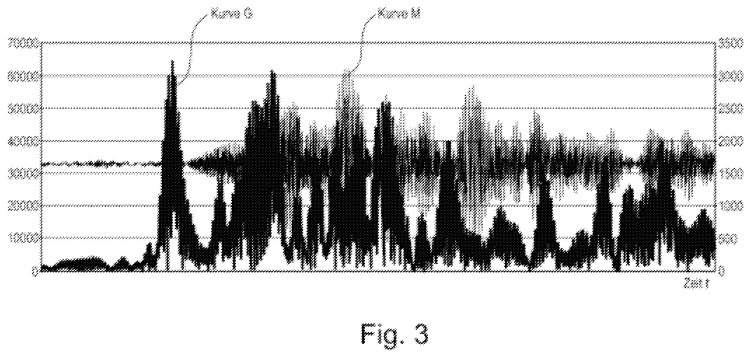

FIG. 3 shows the example of a signal as recorded by the microphone (curve M). Curve G is the output signal of the correlator downstream of the rectifier (see FIG. 2). In this example, the position is very clearly recognizable (first peak in curve G), but there is a great amount of echo signals in the indoor area which have a significant peak height. The level of the echoes is considerably higher than the signal to be measured. Scale of approx. 10 ms. The signal is then further filtered (moving average filter, 4-fold oversampling), and a peak detector determines all local maxima (see also the reference to FIG. 2).

The practice of the present disclosure is not limited to the preferred exemplary embodiments set forth above. Instead, a number of variants may be contemplated which make use of the solution shown even in case of basically different embodiments. A further idea of the present disclosure proposes that it is possible to switch back and forth dynamically between the position detection according to the invention and another position detection, so that, e.g., from a certain distance between flying object and base station, a switch can be made to a GPS-based positioning and, on the flight back, for example when changing into landing operation, one can switch back to the ultrasound solution from a certain distance value. Other signal processing solutions and other technical topologies of the sensors, units, processors and the like used are also conceivable. A further advantage of the present disclosure also lies in the overall very low power consumption or energy consumption.

1. A system for detecting the position of a flying body,
which has at least two ultrasonic transducers arranged on the flying body, and a stationary or mobile base station positionable locally temporally, which is able to be arranged in a preferably freely selectable reference position, said base station having a signal analysis device and a plurality of at least three acoustic transducers, which are arranged on the base station in a mutually spaced manner and which are designed to receive the ultrasonic signals of the two ultrasonic transducers, and a radio controller, which is designed to communicate with the flying body and control the same by means of radio signals, preferably by means of radio signals according to a frequency-hopping spread spectrum method, wherein the system is designed to determine the position (x, y, z) of the flying body from the ultrasonic signals of each of the two ultrasonic transducers received from the base station, preferably together with the time information of the radio reference signal from the radio signals used for controlling the flying body.

2. The system according to claim 1, wherein the ultrasonic transducers are designed to send chirp signals in the ultrasonic range.

3. The system according to claim 1, wherein the ultrasonic signals of the at least two ultrasonic transducers are used for distance measurement by means of transit time measurement from the flight body to the base station.

4. The system according to claim 1, wherein the acoustic transducers represent microphones, preferably broadband microphones, arranged at the base station.

5. The system according to claim 1, wherein the position (x, y, z) determined by the base station is transmitted to the flight body via the radio channel or via the FHSS signals.

6. The system according to claim 1, wherein an alignment of the flight body is also determined from at least two chirp signals of the two ultrasonic transducers, in particular by first receiving the chirp signals of the one ultrasonic transducer sent by the acoustic transducers and then the chirp signals of the at least second ultrasonic transducer sent by the acoustic transducers.

7. The system according to claim 1, wherein a plurality of channels or signal links is used in the ultrasonic signal analysis simultaneously in parallel.

8. The system according to claim 1, wherein the ultrasonic transducers are designed to be alternately switchable, so that an optimized spatial and angular coverage can be realized in the ultrasonic signal transmission.

9. A method of determining the position of a remotely controllable dynamically movable flying body on which at least two ultrasonic transducers are mounted, preferably with a system according to the features of claim 1, comprising the steps of:
a. providing and positioning a base station at a selected reference position, wherein the base station is equipped with a signal analysis device and at least three acoustic transducers for receiving ultrasonic signals of the flying body;
b. providing a radio controller which is designed to communicated with the flying body by means of radio signals, preferably by means of radio signals according to the frequency-hopping spread spectrum method, and to control the same,
c. sending ultrasonic signals from the two ultrasonic transducers to the base station, in particular chirp signals in the ultrasonic range;
d. detecting and analyzing the ultrasonic signals received from the acoustic transducers by the signal detection device;
e. detecting the time information of the radio reference signal from the radio signals used to control the flying body; and
f. determining the positional data (x, y, z) of the flying body from the detected reference signal and the ultrasonic signals.

10. The system according to claim 2, wherein the chirp signals of the at least two ultrasonic transducers are used for distance measurement by means of transit time measurement from the flight body to the base station.

11. The system according to claim 10, wherein the acoustic transducers represent microphones, preferably broadband microphones, arranged at the base station.

12. The system according to claim 11, wherein the position (x, y, z) determined by the base station is transmitted to the flight body via the radio channel or via the FHSS signals.

13. The system according to claim 12, wherein an alignment of the flight body is also determined from at least two chirp signals of the two ultrasonic transducers, in particular by first receiving the chirp signals of the one ultrasonic transducer sent by the acoustic transducers and then the chirp signals of the at least second ultrasonic transducer sent by the acoustic transducers.

14. The system according to claim 13, wherein a plurality of channels or signal links is used in the ultrasonic signal analysis simultaneously in parallel.

15. The system according to claim 14, wherein the ultrasonic transducers are designed to be alternately switchable, so that an optimized spatial and angular coverage can be realized in the ultrasonic signal transmission.

16. A method of determining the position of a remotely controllable dynamically movable flying body on which at least two ultrasonic transducers are mounted, preferably with a system according to the features of claim 8, comprising the steps of:
a. providing and positioning a base station at a selected reference position (x_{R}, y_{R}, z_{R}), wherein the base station is equipped with a signal analysis device and at least three acoustic transducers for receiving ultrasonic signals of the flying body;
b. providing a radio controller which is designed to communicate with the flying body by means of radio signals, preferably by means of radio signals according to the frequency-hopping spread spectrum (FHSS) method, and to control the same,
c. sending ultrasonic signals from the two ultrasonic transducers to the base station, in particular chirp signals in the ultrasonic range;
d. detecting and analyzing the ultrasonic signals received from the acoustic transducers by the signal detection device;
e. detecting the time information (time measurement) of the radio reference signal from the radio signals used to control the flying body; and
f. determining the positional data (x, y, z) of the flying body from the detected reference signal and the ultrasonic signals.
